(19) United States
(12) Patent Application Publication
(10) Pub. No.: US 2026/0320396 A1
(43) Pub. Date: Oct. 15, 2026

(54) A Training Regime for Physics informed Neural Networks (PINNs) for turbulent flows with Reynolds Averaged Navier Stokes formulation (RANS)

(71) Applicant: Siemens Aktiengesellschaft, München (DE)

(72) Inventors: Shinjan Ghosh, Princeton, NJ (US); Amit Chakraborty, Princeton, NJ (US); Georgia Olympia Brikis, Princeton, NJ (US); Biswadip Dey, Princeton, NJ (US)

(73) Assignee: Siemens Aktiengesellschaft, München (DE)

(21) Appl. No.: 19/482,007

(22) PCT Filed: May 16, 2024
(86) PCT No.: PCT/US2024/029685

§ 371 Date: Nov. 6, 2025

Related U.S. Application Data
(60) Provisional application No. 63/502,670, filed on May 17, 2023.

(51) Int. Cl. G06N 3/084

(52) U.S. Cl. CPC G06N 3/084

(57) ABSTRACT

Physics informed neural networks (PINNs) can exploit automatic differentiation and incorporate the underlying PDEs to approximate a solution field. PINNs combine differential equations, such as compressible and incompressible Navier-Stokes equations, with experimental data or high-fidelity numerical simulations. Conventional approaches to training PINNs involve introducing data and PDE losses simultaneously at the start of the training phase, often with equal weight multipliers. It is recognized herein, however, that such training approaches often result in noisy training losses, slow convergence, and high validation error.

### BACKGROUND

Traditional approaches to designing complex devices and systems, for example, aerodynamic surfaces and thermal management systems, involve a back-and-forth interplay between exploring the design and operating space and assessing performance through computationally intensive computational fluid dynamics (CFD) simulations. However, the high computational cost associated with high-fidelity CFD solvers curtails the overall scope of the design optimization, often leading to suboptimal design choices. In this context, neural networks, with their expressiveness to capture pertinent functional relationships between initial/boundary conditions and the solution field of a partial differential equation (PDE) and the ability to predict simulation outcomes by invoking a single forward pass, offer an excellent tool for building fast and accurate surrogate models for CFD simulations. Such deep learning based approaches can accelerate design evaluations significantly, facilitating the generation of enhanced design choices through fast predictions of simulation outcomes.

In particular, physics-informed neural networks (PINNs) can exploit automatic differentiation and incorporate the underlying PDEs to approximate a solution field. PINNs combine differential equations, such as compressible and incompressible Navier-Stokes equations, with experimental data or high-fidelity numerical simulations. Conventional approaches to training PINNs involve introducing data and PDE losses simultaneously at the start of the training phase, often with equal weight multipliers. It is recognized herein, however, that such training approaches often result in noisy training losses, slow convergence, and high validation error.

### BRIEF SUMMARY

Embodiments of the invention address and overcome one or more of the described-herein shortcomings or technical problems by providing methods, systems, and apparatuses for predicting flow fields (e.g., velocity and pressure) in high Reynolds number turbulent flow regimes. To account for the additional complexity introduced by turbulence, a Reynolds-averaged Navier-Stokes Physics-informed neural network (RANS-PINN) can employ a 2-equation eddy viscosity model based on a Reynolds-averaged Navier-Stokes (RANS) formulation. Furthermore, embodiments define novel training approach for PINNs that ensures effective initialization and balance among the various components of the loss function.

In an example aspect, a turbulent flow surrogate model system defines a plurality of neural networks that are trained networks with an input so as to define a pre-training stage. Each of the neural networks of the plurality of neural networks are configured to generate a respective output variable associated with a turbulent flow. During the pre-training stage, each of the neural networks of the plurality of neural networks only back-propagate respective data losses. After the pre-training stage, the plurality of neural networks can be trained with the input so as to define a training stage. During the training stage, a loss function defined by a plurality of partial differential equation (PDE) constraints and the data losses can be propagated to the plurality of neural networks. The system can balance the PDE constraints until convergence of the neural networks, so as to generate a Reynolds-averaged Navier Stokes (RANS) physics informed neural network (PINN) system configured to predict flow fields in turbulent flow regimes. In an example, during the pre-training stage, each of neural networks of the plurality of neural networks is updated independently from each other with their respective data losses.

In another example aspect, the plurality of neural networks includes a first neural network that generates a first output variable representative of a first directional component (x-component) of velocity; a second neural network that generates a second output variable representative of a second directional component (e.g., y-component) of velocity that is substantially perpendicular to the first directional component; a third neural network that generates a third output variable representative of pressure; a fourth neural network that generates a fourth output variable representative of kinetic energy; and a fifth neural network that generates a fifth output variable representative of a dissipation rate. The input to the neural networks can define positional coordinates and a Reynolds number associated with the positional coordinates. In an example, turbulence in an internal flow is characterized by a Reynolds number greater than about 3000, for instance between 3000 and 4000.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example RANS-PINN computing system that includes a pre-training module and a physics informed fine-tuning module, in accordance with an example embodiment.

FIG. 2 illustrates a computing environment within which embodiments of the disclosure may be implemented.

### DETAILED DESCRIPTION

As an initial matter, it is recognized herein that current approaches to predicting turbulent flows using physics-informed neural networks (PINNs), such as flows for aerospace and automobile design, among others, do not yield accurate predictions beyond a certain Reynolds number (turbulence). In some cases, current training regimes are unable to address a greater range of Reynolds number so as to address high Reynolds numbers associated with turbulent flows. It is further recognized herein that generic training regimes can cause lack of convergence in the evolution of the loss function (resulting in poor predictive performance) with the inclusion of additional turbulence modeling physics, which have a bidirectional coupling with Navier Stokes (representative of momentum conservation) and continuity (representative of mass conservation) equations. Some approaches rely on large eddy simulations (LES) and other high fidelity studies, but the data for which can be difficult or impossible to generate.

It is further recognized herein that purely data-driven approaches without any physics-informed regularization, such as regression-based approaches using neural networks or other machine learning (ML) techniques, can result in a lack of generalization, and a requirement for higher amounts of data in the absence of physics constraints.

Design optimization problems, using parametric models have been traditionally solved using computational fluid dynamics (CFD) simulations. If a data based surrogate model is used, a greater number of simulations data points might be needed to train a surrogate that has a lack of governing physics-based constraints. It is recognized herein that, in the absence of enough computationally expensive simulation data, such surrogates can provide inaccurate solutions. Further still, entire flow field solutions can only be obtained using CFD simulations, which can be computationally intensive and time consuming.

Thus, in accordance with various embodiments, data-based constraints are used to pre-train neural networks. For example, in accordance with various embodiments, a neural network is trained for each output variable. Such training can use the same input variables for each neural network. In various examples, when the pre-training is complete, PDE constraints are introduced into the loss function with each component having equal weights. During this introduction of PDE losses, a logarithmic function of the error can be used in case of the epsilon equation. The training can be performed until convergence is reached.

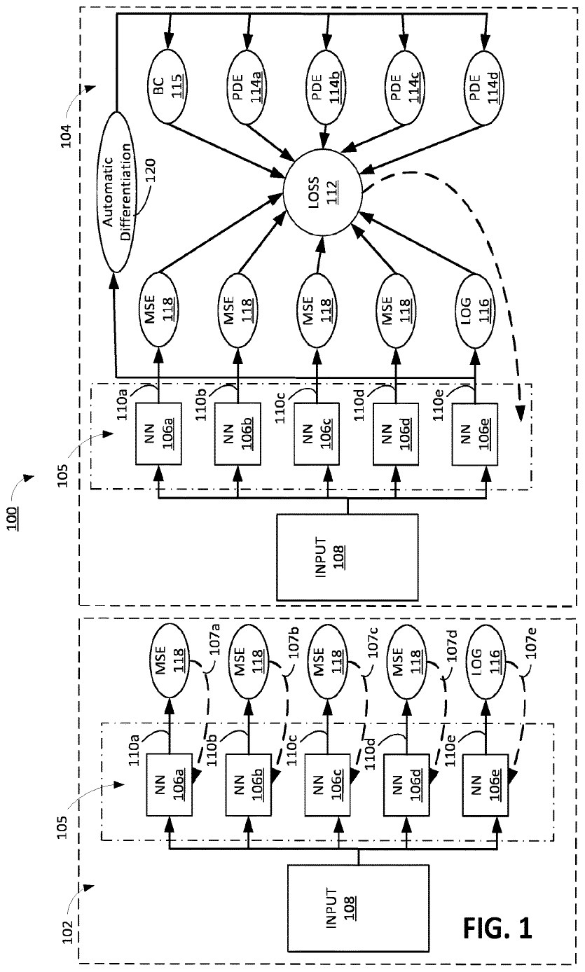

Referring to FIG. 1, an example RANS-PINN computing system 100 (or turbulent flow surrogate model system) can define a pre-training module 102 and a physics-informed fine-tuning module 104. The pre-training module 102 and the physics-informed fine-tuning module 104 can each define a plurality of neural networks 105. In particular, for example and without limitation, the neural networks 105 can include a first neural network or Fourier neural operator 106a, a second neural network or Fourier neural operator 106b, a third neural network or Fourier neural operator 106c, a fourth neural network or Fourier neural operator 106d, and a fifth neural network or Fourier neural operator 106e. Each of the neural networks 106a-e can receive an input variable 108 that is the same. Based on the input variable 108, each of the neural networks can generate respective output variables 110a-e that are different than each other. In particular, for example, the input variable 108 can define positional coordinates (e.g., x and y) and the associated Reynolds number (Re). In an example, the first neural network 106a generates a first output variable 110a that represents a first directional component (e.g., x-component) of velocity (u), the second neural network 106b generates a second output variable 110b that represents a second directional component (e.g., y-component) of velocity (v) that is substantially perpendicular to the first directional component of velocity, the third neural network 106c generates a third output variable 110c that represents pressure (p), the fourth neural network 106d generates a fourth output variable 110d that represents turbulent kinetic energy (k), and the fifth neural network 106e generates a fifth output variable 110c that represents turbulent dissipation rate (e).

The underlying physics of the RANS-PINN computing system 100 is governed by the continuity equation (to conserve mass), Navier-Stokes equation (to conserve momentum), and a k−ε turbulence model (to model turbulent viscosity). By letting u and p denote the flow velocity (i.e., a concatenated vector of u and v) and pressure, respectively, the Navier-Stokes and continuity equations can be expressed as equation (1) and equation (2), respectively:

∇·u=0 (1)

ρ(u·∇)u+∇(p)−μ_{eff}∇²u=0, (2)

where, ρ is the density of the fluid, ∇ denotes the vector differential operator, and μ_{eff} represents the effective viscosity, for instance the sum of the molecular viscosity (μ) and the turbulent viscosity (μₜ) (e.g., μ_{eff}=μ+0.09k²/ε). The k−ε turbulence model can be expressed as:

$$k : ∇ ( ρ u k ) = ∇ [ ( μ + \frac{{μ}_{f}}{{σ}_{k}} ) ∇ k ] + {P}_{k} - ε \qquad ( 3 )$$

$$ε : ∇ ( ρ u ε ) = ∇ [ ( μ + \frac{{μ}_{f}}{{σ}_{ε}} ) ∇ ε ] + ( {C}_{1} {P}_{ε} + {C}_{2} ε ) \frac{ε}{k} \qquad ( 4 )$$

where, C₁=1.44, C₂=1.92, σₖ=1, and σ_{ε}=1.3 are empirical model constants. Furthermore, Pₖ and P_{ε} can define production terms. The Reynolds number (Re) can be defined as Re=ρuᵢₙₗₑₜL/μ, where uᵢₙₗₑₜ is the inlet velocity and L is the characteristic length.

Referring again to FIG. 1, the neural networks 105 can be connected to a regularized loss function 112 in which the physics-informed regularization term is computed via individual nodes representative of PDE loss components 114a-d and a boundary loss component or boundary condition (BC) 115. It is recognized herein that conventional approaches to training PINNs involve introducing data and PDE losses simultaneously at the start of the training phase, often with equal weight multipliers. It is further recognized herein, however, that such approaches often result in noisy training losses, slow convergence, and high validation error. The RANS-PINN computing system 100 addresses these challenges by employing the pre-training module 102 that only uses the data-driven supervision loss. During pre-training, each of the individual networks 106a-e can be updated independently using their corresponding data loss 107a-e. Following pre-training, the boundary condition 115 and the PDE constraints (PDE losses 114a-d can be introduced into a combined loss function 112. In addition, the fine-tuning module 104 can include an automatic differentiation module 120 configured to compute the various derivatives of the predicted variables that are needed to evaluate the individual components of the physics-informed regularization term. Furthermore, in various examples, to normalize the effect of the individual components 114a-d of the PDE loss function, the PDE loss components 114a-d are scaled/weighted by the inverse of their corresponding residual values. The system 100 can then perform adaptive moment estimation (Adam) with a decaying step size (e.g., an initial step size of 0.001 and a decay rate of 0.95) until the training loss converges. To address the technical challenges associated with abrupt changes observed (in multiple orders of magnitude) in the turbulence dissipation term near wall and free shear regions, the system 100 uses a logarithmic loss function for both data losses 116 and PDE losses 114d associated with e. The other losses can be computed using a mean square error MSE loss function 118. The overall loss function 112 can then be expressed as:

[symbol]

= [symbol] _{data}+ [symbol] _{BC}+ [symbol] _{PDE}, (5)

where the PDE loss is defined with weights (λ) as:

[symbol]

_{PDE}=λ₁ [symbol] _{NS}+λ₂ [symbol] _{Cont}+λ₃ [symbol] ₖ+λ₄ [symbol] _{ε} (6)

Thus, referring in particular to FIG. 1, the total loss function can be defined by the sum of data-driven supervision loss terms using MSE 118 and logarithmic loss 116, a BC loss 115, and the PDE lost components 114a-d, in particular a Navier-Stokes loss 114a ( [symbol] _{NS}), continuity loss 114b ( [symbol] _{Cont}), a turbulent kinetic energy loss 114c ( [symbol] ₖ), and a turbulent dissipation rate loss 114d ( [symbol] _{ε}). Furthermore, the PDE loss components 114a-d can each be weighted (λ₁₋₄) using the inverse of their residual values at the end of the pre-training stage.

In an example, data is generated using a CFD simulation. In the example, a Simcenter STAR-CCM+ (Release 17.02.008) is used to simulate turbulent flow scenarios using RANS CFD with the k-E turbulence model. Automatic meshers are used for each test case, with refinement near walls for low wall y+, and wall functions for turbulence quantities. Moreover, wake refinements are used to simulate flow around an example cylinder and the airfoil. The data generated from the simulation is then normalized using the non-dimensional version of the underlying dynamics (i.e., continuity, Navier-Stokes, and RANS equations). The range of various variables can be brought to a comparable order of magnitude by normalizing the spatial coordinates, the velocity, and the pressure with the characteristic length, the inlet velocity, and the dynamic pressure, respectively. Later, the data can be denormalized again before visualization.

It will be understood that while the training described herein can generate the parametric PINNs 105 capable of accommodating varying Reynolds numbers Re, an initial investigation is conducted using single CFD cases (at a fixed Re) to assess the optimal training regime described herein. Flow over a cylinder is a well-studied problem in CFD, for both laminar and turbulent flows. The cylindrical obstacle causes a stagnation zone, and the flow diverts around the obstacle. As a result, flow separation occurs and vortex shedding can be seen in the wake. However, steady RANS models average out the periodic unsteady behavior, resulting in the time averaged flow field. In an example test case, a constant velocity inlet is employed, along with symmetry planes on the top and bottom walls and a zero pressure outlet. In an example pre-training and training stage, 3000 spatially distributed CFD data points are randomly sampled, with an additional 3000 points dedicated to PDE losses. Major losses can occur around the cylinder walls, which is known to be a challenging region for turbulence models due to steep gradients. Example validation error values are shown in Table 1. In conclusion, the proposed training regime described herein for the RANS-PINN system 100 exhibits lower validation losses as well as superior predictive performance as compared to previous approaches.

TABLE 1
Example Validation Errors

| Loss Function | X Vel. (u) | Y Vel. (v) | Pressure (p) |
|---|---|---|---|
| DATA Only | 0.205 | 0.284 | 0.029 |
| DATA + PDE | 0.187 | 0.474 | 0.066 |
| DATA + PDE w/Log-loss | 0.014 | 0.03 | 0.105 |

In another example, the system 100 is tested on other geometries, in particular a first geometry that involves airfoils which represents external flows, where a pressure gradient is established between the top and bottom surfaces due to acceleration of flow over the top surface), which causes lift; and a second geometry that consists of a backwards facing step, where a separation bubble forms due to sudden expansion in the channel. This leads to flow separation and detachment and then re-attachment. Both cases had no-slip walls and constant velocity inlet boundary conditions with a zero-pressure exit. Low validation error shown in Table 2 and visual inspection of spatial distributions (e.g., velocity and pressure) show that the flow fields have been successfully predicted.

TABLE 2
Example Validation Errors for NACA airfoil (Re = 3 ×
10⁵) and backward facing step (Re = 5600)

| CASE | X Vel. (u) | Y Vel. (v) | Pressure (p) |
|---|---|---|---|
| NACA 2412 | 0.091 | 0.131 | 0.022 |
| Backwards Facing Step | 0.024 | 0.146 | 0.137 |

In another example, after illustrating the training regime described herein with the example flow geometries, the flow over a cylinder problem can be revisited for creating a parametric PINN, for instance the PINN 105. The parametric PINN can predict outcomes of CFD simulations for unseen flow scenarios, in particular for any given Reynolds number (Re), which depends on the inlet velocities. For example, the Reynolds number can be provided as the input 108 (e.g., in addition to positional values) to the individual neural networks 105. As an example test case, CFD simulations for six different Reynolds numbers ranging from 2800 to 5600 were run, with uniform spacing between the values. In the example, 3000 spatial data points are sampled from each simulation. The spatial data points are utilized along with PDE losses to train the parametric PINN with Re as the underlying parameter. Although each CFD simulation has 61000 mesh data points, in the example, the parametric PINN can use only 3000 points, resulting in faster convergence. By leveraging the parametric PINN, flow fields can be predicted any given Reynolds number. Without being bound by theory, such embodiments are highly beneficial for design optimization and exploration studies, as it eliminates the need for additional CFD data to predict primary flow variables across the entire solution domain. Moreover, compared to the traditional approaches, where each CFD simulation run takes approximately 24 core minutes, the parametric PINN can yield results in a near real-time fashion, significantly accelerating the overall process. Table 3 shows overall example error metrics for validation in the case of the parametric PINN.

TABLE 3
Example Generalization error for parametric PINNs (unseen cases)

| CASE | X Vel. (u) | Y Vel. (v) | Pressure (p) |
|---|---|---|---|
| Re = 3140 | 0.139 | 0.289 | 0.164 |
| Re = 5700 | 0.153 | 0.200 | 0.079 |

Thus, as described herein with reference to FIG. 1, a turbulent flow surrogate model system can include a memory having a plurality of modules stored thereon; and a processor for executing the modules. The modules can include a pre-training module configured to train a plurality of neural networks with an input, so as to define a pre-training stage. Each of the neural networks of the plurality of neural networks can be configured to generate a respective output variable associated with a turbulent flow. During the pre-training stage, each of the neural networks can be further configured to back-propagate only respective data losses. The modules can further include a physics-informed fine-tuning module configured to, after the pre-training stage, train the plurality of neural networks with the input so as to define a training stage. During the training stage, the physics-informed fine-tuning module can be further configured to propagate a loss function defined by a plurality of partial differential equation (PDE) constraints and the data losses to the plurality of neural networks. The fine-tuning module can balance the PDE constraints until convergence of the neural networks, so as to generate a Reynolds-averaged Navier Stokes (RANS) physics informed neural network (PINN) system configured to predict flow fields in turbulent flow regimes. In an example, during the pre-training stage, each of neural networks of the plurality of neural networks is updated independently from each other with their respective data losses.

In another example aspect, the plurality of neural networks includes a first neural network that generates a first output variable representative of a first directional component (x-component) of velocity; a second neural network that generates a second output variable representative of a second directional component (e.g., y-component) of velocity that is substantially perpendicular to the first directional component; a third neural network that generates a third output variable representative of pressure; a fourth neural network that generates a fourth output variable representative of kinetic energy; and a fifth neural network that generates a fifth output variable representative of a dissipation rate. The input to the neural networks can define positional coordinates and a Reynolds number associated with the positional coordinates. In an example, turbulence in an internal flow is characterized by a Reynolds number greater than about 3000, for instance between 3000 and 4000.

Without being bound by theory, the novel training regime described herein can ensure the successful integration of RANS turbulence model physics into PINNs. Once trained with a limited amount of CFD data, the RANS-PINN system 100 can yield accurate predictions of overall flow fields for a single Reynolds number. Building upon the successful outcomes of these evaluations for different flow geometries (e.g., flow over a cylinder, a backward-facing step, and a NACA 2412 airfoil), a parametric version of the RANS-PINN is generated to predict flow over a cylinder for any given/unforeseen Reynolds numbers. The parametric RANS-PINN, which highlights how whole simulation cases can be inferred without requiring any CFD data from that specific Reynolds number, offers significant potential in solving design exploration and inverse problems for many real-world applications including, but not limited to, the design of automotive vehicles, turbine blades, marine vessels, etc.

Without being bound by theory, turbulence models described herein can hold significant importance in many industrial and academic settings where a lack of computing resources prevents the use of Direct Numerical Simulation (DNS) and Large Eddy Simulation (LES). In accordance with various embodiments, design and inverse problems in many real-world cases can be addressed by employing a turbulent flow PINN, such as the RANS-PINN 100. The ability to reconstruct a flow field from limited data can help in real-world problems with limited sensor data. Moreover, a parametric PINN trained with minimal CFD data adds significant value to design exploration and optimization by offering a convenient, fast, and computationally efficient means to predict simulation outcomes.

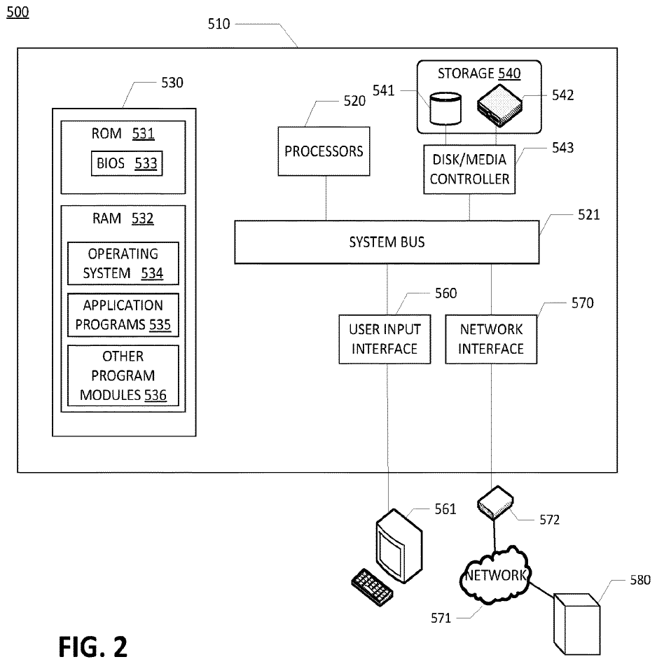

FIG. 2 illustrates an example of a computing environment within which embodiments of the present disclosure may be implemented. A computing environment 500 includes a computer system 510 that may include a communication mechanism such as a system bus 521 or other communication mechanism for communicating information within the computer system 510. The computer system 510 further includes one or more processors 520 coupled with the system bus 521 for processing the information. The computer system 100 may include, or be coupled to, the one or more processors 520.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 2, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may also include a field device interface 565 coupled to the system bus 521 to control a field device 566, such as a device used in a production line. The computer system 510 may include a user input interface or GUI 561, which may comprise one or more input devices, such as a keyboard, touchscreen, tablet and/or a pointing device, for interacting with a computer user and providing information to the processors 520.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 (or solid state drive) and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 500 may further include the computer system 510 operating in a networked environment using logical connections to one or more remote computers, such as remote computing device 580. The network interface 570 may enable communication, for example, with other remote devices 580 or systems and/or the storage devices 541, 542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 2 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method performed by a turbulent flow surrogate model system that defines a plurality of neural networks, the method comprising:
training the plurality of neural networks with an input so as to define a pre-training stage, each of the neural networks of the plurality of neural networks configured to generate a respective output variable associated with a turbulent flow;
during the pre-training stage, each of the neural networks of the plurality of neural networks only back-propagating respective data losses;
after the pre-training stage, training the plurality of neural networks with the input so as to define a training stage;
during the training stage, propagating a loss function defined by a plurality of partial differential equation (PDE) constraints and the data losses to the plurality of neural networks; and
balancing the PDE constraints until convergence of the neural networks, so as to generate a Reynolds-averaged Navier Stokes (RANS) physics informed neural network (PINN) system configured to predict flow fields in turbulent flow regimes.

2. The method as recited in claim 1, the method further comprising:
during the pre-training stage, updating each of the plurality of neural networks independently from each other with their respective data losses.

3. The method as recited in claim 1, the method further comprising:
a first neural network of the plurality of neural networks generating a first output variable representative of a first directional component of a velocity;
a second neural network of the plurality of neural networks generating a second output variable representative of a second directional component of the velocity that is substantially perpendicular to the first directional component of velocity;
a third neural network of the plurality of neural networks generating a third output variable representative of pressure;
a fourth neural network of the plurality of neural networks generating a fourth output variable representative of kinetic energy; and
a fifth neural network of the plurality of neural networks generating fifth output variable representative of a dissipation rate.

4. The method as recited in claim 1, wherein the input defines positional coordinates and a Reynolds number associated with the positional coordinates.

5. The method as recited in claim 1, wherein the turbulent flow defines a Reynolds number greater than 3000.

6. A turbulent flow surrogate model system comprising:
a memory having a plurality of modules stored thereon; and
a processor for executing the modules, the modules comprising:
a pre-training module configured to train a plurality of neural networks with an input, so as to define a pre-training stage, each of the neural networks of the plurality of neural networks configured to:
generate a respective output variable associated with a turbulent flow; and
during the pre-training stage, back-propagate only respective data losses;
a physics-informed fine-tuning module configured to:
after the pre-training stage, train the plurality of neural networks with the input so as to define a training stage;
during the training stage, propagate a loss function defined by a plurality of partial differential equation (PDE) constraints and the data losses to the plurality of neural networks; and
balance the PDE constraints until convergence of the neural networks, so as to generate a Reynolds-averaged Navier Stokes (RANS) physics informed neural network (PINN) system configured to predict flow fields in turbulent flow regimes.

7. The turbulent flow surrogate model system as recited claim 6, wherein the pre-training module is further configured to, during the pre-training stage, update each of the plurality of neural networks independently from each other with their respective data losses.

8. The turbulent flow surrogate model system as recited claim 6, wherein the plurality of neural networks further comprise:
a first neural network configured to generate a first output variable representative of a first directional component of a velocity;
a second neural network configured to generate a second output variable representative of a second directional component of the velocity that is substantially perpendicular to the first directional component;
a third neural network configured to generate a third output variable representative of pressure;
a fourth neural network configured to generate a fourth output variable representative of kinetic energy; and
a fifth neural network configured to generate fifth output variable representative of a dissipation rate.

9. The turbulent flow surrogate model system as recited in claim 6, wherein the input defines positional coordinates and a Reynolds number associated with the positional coordinates.

10. The turbulent flow surrogate model system as recited in claim 6, wherein the turbulent flow defines a Reynolds number greater than 3000.
